(19) United States
(12) Patent Application Publication
(10) Pub. No.: US 2023/0057005 A1
(43) Pub. Date: Feb. 23, 2023

(54) SLIDING VEHICLE DOOR

(71) Applicant: ev Transportation Services, Inc., Brookline, MA (US)

(72) Inventor: Gregory L. Horne, Euless, TX (US)

(21) Appl. No.: 17/890,918

(22) Filed: Aug. 18, 2022

Related U.S. Application Data
(60) Provisional application No. 63/234,846, filed on Aug. 19, 2021.

(51) Int. Cl. E05D 15/06

(52) U.S. Cl. CPC E05D 15/0669; E05D 15/0686; E05Y 2201/64; E05Y 2201/684; E05Y 2201/688; E05Y 2900/531

(57) ABSTRACT

A sliding door system for a vehicle includes a sliding door including an upper edge and a lower edge; a lower roller coupled to the lower edge of the sliding door, the lower roller defining a groove; a lower guide coupled to the lower edge of the sliding door adjacent to the lower roller, the lower guide defining a groove; an upper roller coupled to the upper edge of the sliding door, the upper roller defining a groove; an upper guide coupled to the upper edge of the sliding door adjacent to the upper roller, the upper guide defining a groove; a lower rail affixed to a frame of the vehicle and disposed vertically below the lower edge of the sliding door, wherein the groove of the lower roller is engaged with the lower rail and wherein the groove of the lower guide partially surrounds the lower rail; and an upper rail affixed to a frame of the vehicle and disposed vertically above the upper edge of the sliding door, wherein the groove of the upper roller is engaged with the upper rail and wherein the groove of the upper guide partially surrounds the upper rail.

### CROSS-REFERENCE TO RELATED APPLICATION

This application claims priority under 35 U.S.C. § 119 to U.S. Provisional Patent Application Ser. No. 63/234,846, filed on Aug. 19, 2021, the entire contents of which are incorporated by reference herein.

### BACKGROUND

Sliding doors in vehicles permit ease of access to a vehicle, while not requiring a large special footprint to open or close the doors. Sliding doors may be advantageous in small vehicles to provide accessibility when parked in tight locations.

### SUMMARY

In an aspect, a sliding door system for a vehicle includes a sliding door with an upper and a lower edge, a forward roller pair coupled to a forward end of the lower edge of the sliding door and defining a first lower groove and a first upper groove. The sliding door system further includes an aft roller pair coupled to an aft end of the lower edge of the sliding door and defining a second lower groove and a second upper groove, a lower rail affixed to a frame of the vehicle and disposed vertically below the lower edge of the sliding door, and engaged with the first lower groove and the second lower groove, and an upper rail affixed to the frame of the vehicle and disposed vertically above the lower edge of the sliding door, the first upper groove and the second upper groove engaged with the upper rail.

Embodiments can include one or any combination of two or more of the following features.

In some instances, the forward roller pair and the aft roller pair each include an upper and a lower roller that are positioned with a relative vertical displacement, and for each roller pair the upper roller is configured to engage the upper rail, and the lower roller is configured to engage the lower rail. In some instances, the relative vertical displacement between each upper and lower roller is adjustable.

In some instances, the upper and lower rollers are formed of a metal alloy and coated with an anti-wear material.

In some instances, a spacing between the upper rail and the lower rail causes a compressive force between the upper and lower rollers when the sliding door rests on the lower rail and the upper rollers contact the upper rail.

In some instances, the first lower groove, first upper groove, second lower groove, and second upper groove have a triangular cross-section.

In some instances, the lower rail and upper rail have a first circular cross-section and the first lower groove, first upper groove, second lower groove, and second upper groove have a second circular cross-section. In some instances the second circular cross section has a radius that is smaller than the first circular cross-section.

In some instances, the system includes one or more guides configured to slot over the lower rail, the surface of the one or more guides includes high density polyethylene (HDPE) or a ceramic.

In some instances, the upper rail and the lower rail are skewed relative to one another

In some instances, a vertical distance between the upper rail and the lower rail toward a front of the vehicle is less than a vertical distance between the upper rail and the lower rail of toward a rear of the vehicle.

In some instances, the upper rail is laterally offset from the lower rail relative to the vehicle.

In some instances, the sliding door includes a guide slot positioned between the upper edge and the lower edge, the guide slot configured to receive a guide roller. In some instances, the guide roller is affixed to the frame of the vehicle and is configured to limit lateral motion of the sliding door.

In some instances, the sliding door is non-planar. In some instances, the sliding door, upper rail, and lower rail follow a non-linear path along the vehicle frame.

In an aspect, a sliding door system for a vehicle includes a sliding door including an upper edge and a lower edge; a lower roller coupled to the lower edge of the sliding door, the lower roller defining a groove; a lower guide coupled to the lower edge of the sliding door adjacent to the lower roller, the lower guide defining a groove; an upper roller coupled to the upper edge of the sliding door, the upper roller defining a groove; an upper guide coupled to the upper edge of the sliding door adjacent to the upper roller, the upper guide defining a groove; a lower rail affixed to a frame of the vehicle and disposed vertically below the lower edge of the sliding door, wherein the groove of the lower roller is engaged with the lower rail and wherein the groove of the lower guide partially surrounds the lower rail; and an upper rail affixed to a frame of the vehicle and disposed vertically above the upper edge of the sliding door, wherein the groove of the upper roller is engaged with the upper rail and wherein the groove of the upper guide partially surrounds the upper rail.

Embodiments can include one or any combination of two or more of the following features.

The lower rail includes a lower rail frame affixed to the frame of the vehicle and a lower tube attached to the top of the lower rail frame. In some cases, the upper rail includes an upper rail frame affixed to the frame of the vehicle and an upper tube attached to the bottom of the upper rail frame. The lower tube and the upper tube are cylindrical. In some cases, the groove in the upper roller has an inner diameter that is greater than an outer diameter of the upper rail tube. In some cases, the groove in the lower roller has an inner diameter that is greater than an outer diameter of the lower rail tube.

A surface of the upper guide that faces the upper rail includes high density polyethylene (HDPE) or a ceramic.

A surface of the lower guide that faces the lower rail includes HDPE or a ceramic.

The lower guides are positioned behind the lower roller along the lower rail relative to the front of the vehicle.

A height of the upper roller relative to the upper edge of the sliding door is adjustable.

The system includes a spring arm configured to adjust a height of the upper roller relative to the upper edge of the sliding door.

The upper and lower rollers are formed of a metal alloy and coated with an anti-wear material.

A spacing between the upper rail and the lower rail causes a compressive force between the upper and lower rollers when the sliding door rests on the lower rail and the upper roller contacts the upper rail.

The lower roller is a first lower roller and the lower guide is a first lower guide. The system includes a second lower roller coupled to the lower edge of the sliding door, wherein the second lower roller is disposed toward the back of the vehicle relative to the first lower roller, and

wherein a groove of the second lower roller is engaged with the lower rail; and a second lower guide coupled to the lower edge of the sliding door. A groove of the lower guide partially surrounds the lower rail. In some cases, the first lower guide and the second lower guide are both positioned between the first lower roller and the second lower roller along the lower rail.

The upper rail and the lower rail are skewed relative to one another. In some cases, a vertical distance between the upper rail and the lower rail toward a front of the vehicle is less than a vertical distance between the upper rail and the lower rail toward a rear of the vehicle.

The upper rail is laterally offset from the lower rail relative to the vehicle.

The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a side view of a sliding door mounted to the side of a vehicle.

FIG. 2 is a side view of a sliding door with certain structural components removed for clarity.

FIG. 3 is a perspective view of an upper roller mechanism and rail for a sliding door.

FIG. 4 is a perspective view of lower roller mechanisms and rail for a sliding door.

FIG. 5 is a cutaway view illustrating rollers engaged with rails for a sliding door.

FIG. 6 illustrates a close up of a roller engaging a rail.

FIG. 7 is a perspective view of a sliding door in an example embodiment with low mounted rails.

FIG. 8 is an interior perspective view of a sliding door with low mounted rails.

FIG. 9 is a side view of a roller pair used in a sliding door with low mounted rails.

FIG. 10 is a cutaway view illustrating rollers engaged with low mounted rails of a sliding door.

### DETAILED DESCRIPTION

This disclosure describes a sliding door system for a vehicle. The disclosed sliding door system is supported by an upper rail and a lower rail positioned above and below the door, respectively, thereby minimizing the width of the door and associated mechanism. The sliding door is captured by the lower and upper rails by at least three rollers, enabling the door to smoothly glide forward and backward on the rails, e.g., without large vibrations or uneven force requirements. Capture guides engage the rails as well as the rollers, allowing the door to smoothly transit the rails and providing feedback friction during motion of the door. The rollers and capture guides can provide self-cleaning and self-lubricating features to the rails, minimizing or eliminating required maintenance throughout the life of the door.

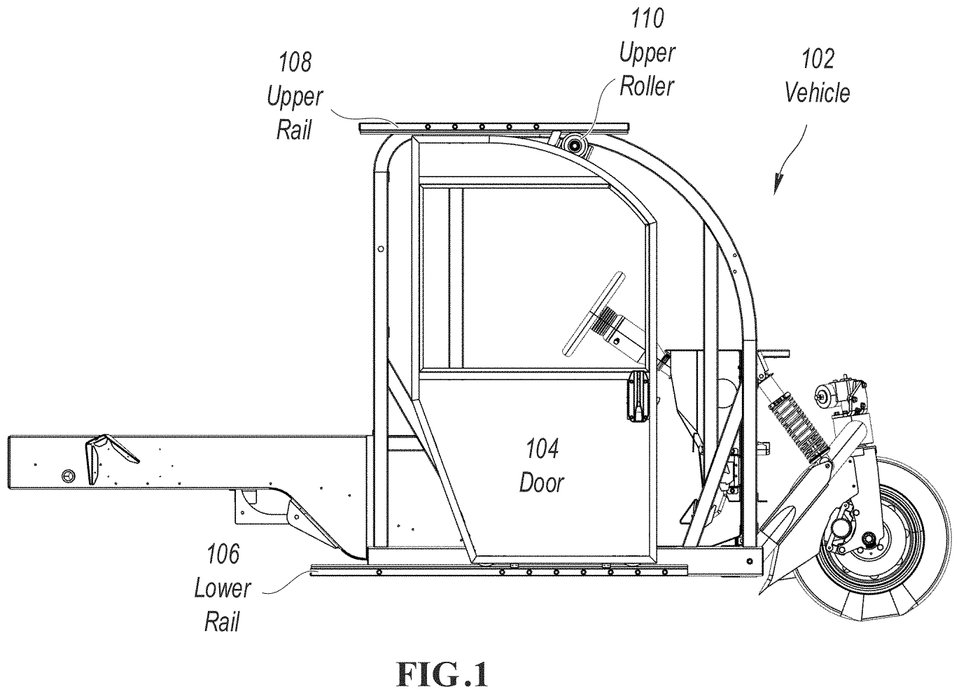

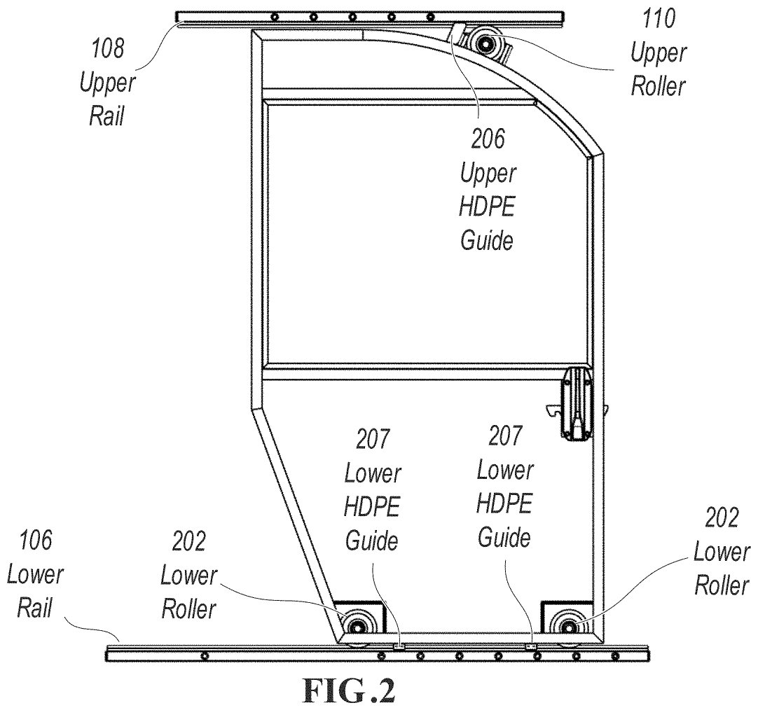

FIG. 1 illustrates a side view of a vehicle 102 having a sliding door 104 mounted on the side of the vehicle 102. The door 104 is captured by an upper rail 108 and lower rail 106, which are positioned directly above and below the door 104, respectively, and affixed to a frame of the vehicle 102 (e.g., welded, bolted, formed as an integral part of the frame, etc.). The door 104 is retained on the rails 106, 108 by one or more rollers (e.g., an upper roller 110 and one or more lower rollers, shown in FIG. 2 as rollers 202) and capture guides (discussed below with respect to FIG. 2). The door 104 has a window 111 that is sized and shaped for compatibility with the mechanisms of the door.

The sliding door system described here is advantageous in that it has a narrow profile when compared to other types of sliding vehicle doors. By positioning the rails directly above and below the door, the overall width of the sliding door system described here is reduced as compared to vehicles having sliding doors in which rails are positioned laterally adjacent to the door. Additionally, the sliding door is able to travel forward and backward without translating laterally relative to the vehicle, such that the vehicle's overall width does not change as the door is opened or shut. This reduces the likelihood of accidental damage to the door and provides ready access to the vehicle even when parked in a tight space. Further, by positioning a rail directly below the sliding door, the weight of the door is supported directly, thus requiring less structural material as compared to a side- or top-mounted sliding door, resulting in a lightweight solution.

In some implementations, instead of positioning the rails above and below the door, support rails can be integrated into the door, or below the door and inside the door. For example, a pair of rails can be positioned below or near the bottom of the door and provide structural support for the weight of the door, and an additional rail or guide slot can be positioned within the door, providing support without contributing to an increase in width of the overall door system.

The dual-rail sliding door system described here is also advantageous in that the sliding door can operate in a non-vertical plane, e.g., the sliding door system can be designed such that horizontal translation of the door does not necessarily remain within a single vertical plane. Instead, because forces can be applied to the door from both the upper and lower rails, the rails can be offset relative to one another, e.g., allowing the door to be designed to accommodate a vehicle cab that tapers to a smaller width toward the roof line of the vehicle. In this design, the door can be shaped to follow the tapering body of the vehicle while still maintaining a high quality seal against the body to reduce weather-related issues. In other words, the sliding door can be non-planar, and have a concave or convex shape that conforms to the body shape of the vehicle.

FIG. 2 is a side view of the sliding door 104 with certain structural components removed for clarity. In FIG. 2, the lower rollers 202, upper roller 110, lower capture guides 207, and an upper capture guide 206 are depicted. The lower rollers 202 and lower capture guides 207 are coupled to a lower edge of the sliding door 104, and the upper roller 110 and upper capture guide 206 are coupled to an upper edge of the sliding door 104. Each roller (e.g., the upper roller 110 and the lower rollers 202) engages with a respective rail 108, 106. A corresponding capture guide (e.g., the upper capture guide 206 or one of the lower capture guides 207) slides along the rail either directly ahead of or behind the roller. The capture guides 206 and 207 are designed to slide along the rails, providing frictional feedback to the door, e.g., to reduce excessive momentum and slamming during operation of the door. The capture guides 206 and 207 also assist in ensuring the upper roller 110 and lower rollers 202 remain engaged on the upper and lower rails 106 and 108, respectively. The capture guides 206 and 207 can be formed of a material capable of engaging the rail and providing frictional reaction forces. For example, the capture guides can be formed of or coated with a polymer, such as high density polyethylene (HDPE), polycaprolactone, polyhydroxyalkanoate polyester, or other polymer material; a ceramic; a metal, such as brass or another suitable alloy, or other appropriate material.

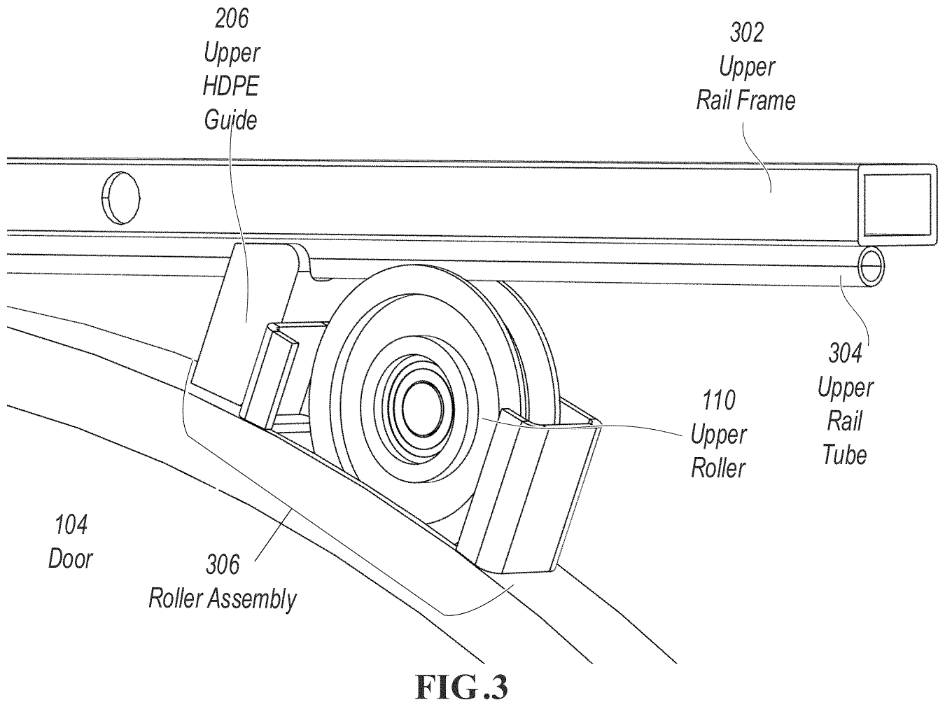

FIG. 3 is a perspective view of a roller assembly 306 for the upper roller 110 that couples the sliding door 104 to the upper rail 108. The roller assembly 306 includes the upper roller 110 and the upper capture guide 206 that together engage with the upper rail 108. Specifically, the upper rail 108 includes an upper rail frame 302 and an upper rail tube 304. The upper rail frame 302 supports the mechanical load of the door 104 and is affixed to the vehicle frame. The upper rail tube 304 is attached to the bottom of the upper rail frame 302 such that the upper rail tube 304 is disposed between the upper rail frame 302 and the sliding door 104. The upper rail tube 304 is a rounded (e.g., cylindrical) tube which engages the upper roller 110 and the upper capture guide 206, supporting the door 104, guiding its motion along the upper rail 108, and preventing the door 104 from moving laterally relative to the vehicle. The capture guide 207 includes a groove that is sized to partially surround with the upper rail tube 304. For instance, the groove in the capture guide 207 has a semi-circular cross-section. The capture guide 206 can slide along the upper rail tube 304 of the upper rail as the door translates forward or backward relative to the vehicle (e.g., open or closed), and when the capture guide 207 engages with the upper rail tube 304 (e.g., contacts the upper rail tube), the contact generates frictional forces and can help prevent the door from gaining too much momentum.

In some examples, the upper roller 110 is a cast steel roller coated with an anti-wear substance, such as a powder coat or a high durability polymer painting, which enhances the life of the roller. In some examples, the upper roller 110 is formed of a durable ceramic or plastic material. When the material of the upper roller 110 is sufficiently durable, no coating is applied to the upper roller.

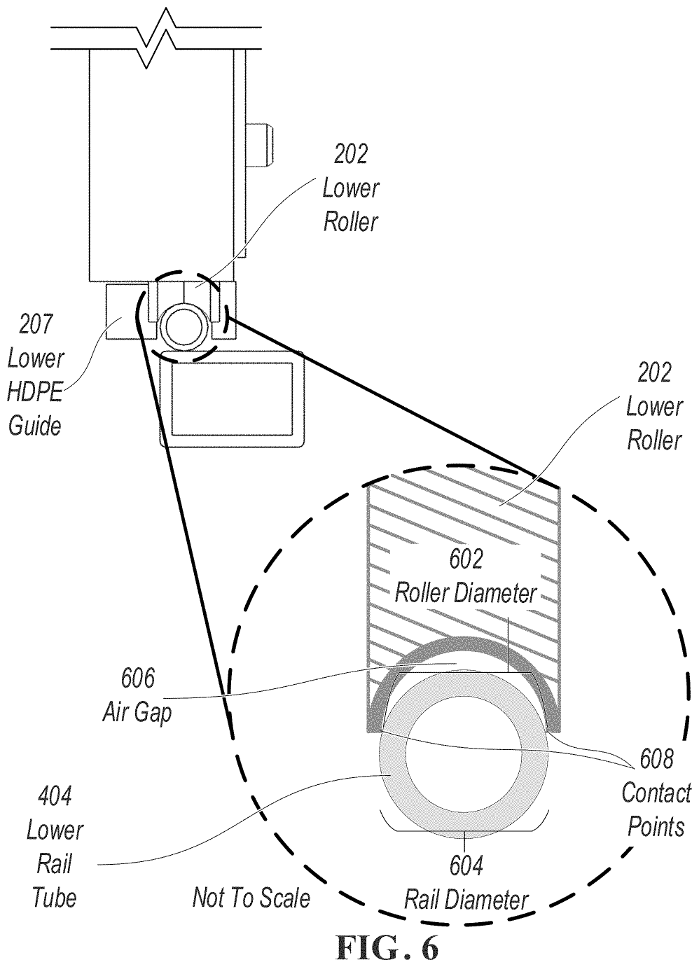

The upper roller 110 features a concave groove around its circumference, which is shaped and sized to engage with the upper rail tube 304. For instance, the groove in the upper roller 110 has a semi-circular cross-sectional shape. The groove in the roller 110 is described in more detail below with respect to FIG. 6. In some implementations, a height of the upper roller 110 relative to the door 104 is adjustable. For example, a spring arm that supports an axle of the upper roller 110 can apply a force to the upper roller 110 that compresses the upper roller 110 into the upper rail tube 304. In some implementations, the height of the upper roller 110 is set based on its mounting location on the door 104. For example, the entire roller assembly 306 can be positioned at a desired location along the curved upper edge of the door 104 and fixed in place with, for example, a set screw. This configuration allows the manufacturer or a user to adjust the compressive forces experienced by the upper roller 110, e.g., to provide adequate contact force and help ensure smooth operation of the door.

The combination of the upper roller 110 and capture guide 206 allows for flexibility in the design of the doors and the cab. The upper roller 110 provides smooth, tactile feedback to a user operating the door, and additionally provides self-cleaning functionality for the upper rail 108, as discussed further below. The capture guide 206 supports the roller 110 and acts as a mechanical safety capable of retaining the door 104 in place. For instance, the capture guide 206 can retain the door 104 in case of a misaligned door, or as normal wear minimizes the positive pressure exerted by the upper roller 110. In some examples, on a properly installed and adjusted door system, the capture guide 206 does not engage or directly contact the rails during ordinary operation. When the capture guide 206 does come into contact with the upper rail 108, a user will feel the drag and friction that arise from this contact, e.g., which can trigger the user to seek a service adjustment. Similar functionality applies to the lower rollers 202 and capture guides 207, the structure of which is discussed below.

In some examples, the configuration of rollers and capture guides provides tactile feedback and frictional forces that make the weight of the sliding door seem to be greater than the actual weight of the door. This configuration enables the door to be made of lightweight materials while still providing a desirable weighted feeling to a user.

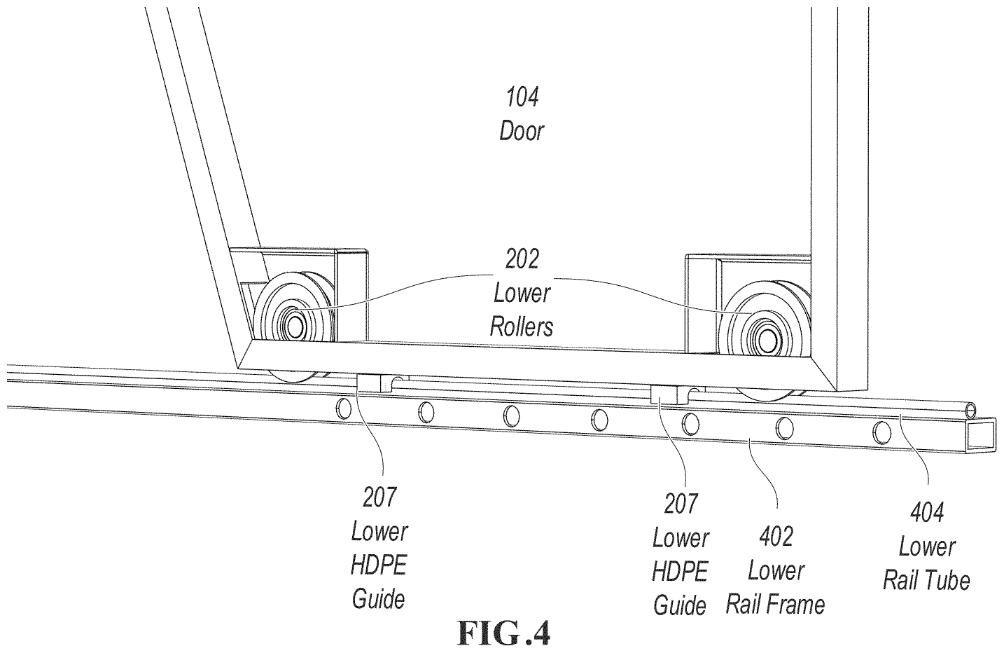

FIG. 4 is a perspective view of lower roller assemblies for the lower rollers 202 that couple the sliding door 104 to the lower rail 106. The lower rollers 202 and lower capture guides 207 can be similar in shape and structure to the upper roller 110 and upper capture guide 206, e.g., as described with respect to FIGS. 2 and 3. In general, the lower rollers 202 support the weight of the door and ride along the lower rail 106, which includes a lower rail frame 402 and a lower rail tube 404. The lower rail tube 404 is attached to the top of the lower rail frame 402 such that the lower rail tube 404 is disposed between the lower rail frame 402 and the sliding door 104. The lower rail frame 402 and lower rail tube 404 can be generally similar in structure to the upper rail frame and tube 302 and 304, respectively, e.g., differing only in length. In some implementations, the lower rail frame 402 and lower rail tube 404 are larger (e.g., have greater diameter or thicker structures) than the upper rail frame and tube 302, 304 to carry the load of the door 104. The height of the lower rollers 202 relative to the sliding door 104 can be adjustable, e.g., as described above for the upper roller 110, to allow the compressive forces experienced by the lower rollers 202 to be adjusted. The functionality and advantages of the lower rollers 202 and capture guides 207 are generally similar to those discussed above for the upper roller 110 and capture guide 206.

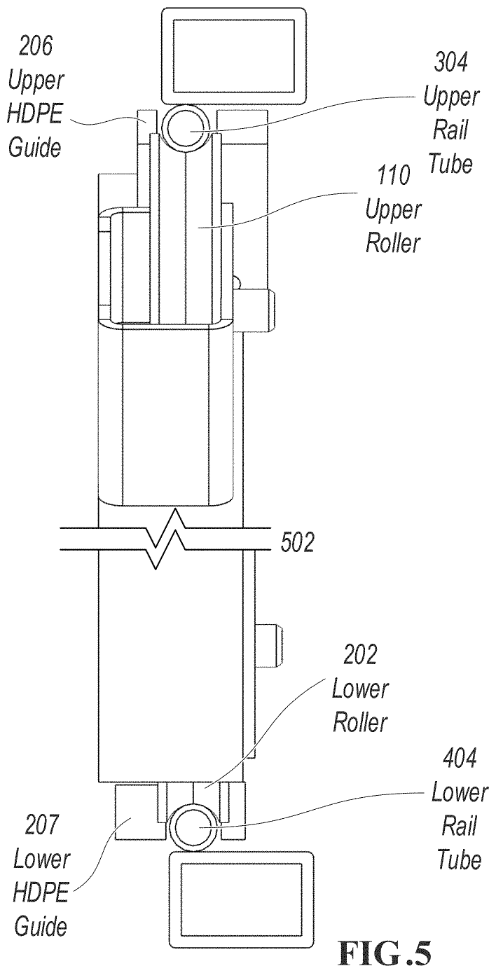

FIG. 5 is a cutaway view, shown from the perspective of the front of the vehicle, illustrating the upper and lower rollers 110, 202 engaged with the rail tubes 304, 404 of the respective upper and lower rails 108, 106. As shown in FIG. 5, the groove in each of the upper roller 110 and upper capture guide 206 engage the upper rail tube 304. Similarly, the groove in each of the lower rollers 202 and lower capture guides 207 engage the lower rail tube 404. It should be noted that FIG. 5 is not to scale, and that a middle portion of the door has been removed by partition 502 for clarity.

FIG. 6 is a close up view of an example configuration of one of the lower rollers 202 engaging the lower rail tube 404. The lower roller 202 has a groove around its circumference that is shaped and sized to engage with the lower rail tube 404. The groove has a semicircular, or nearly semicircular cross section with a diameter (denoted as the roller diameter 602 in FIG. 6). The lower rail tube 404 has a circular or nearly circular cross section with an outer diameter (denoted as the rail diameter 604 in FIG. 6). The roller diameter 602 is larger than the rail diameter 604. In a specific example, the roller diameter is between 13 and 14 mm and the rail diameter is between 12 and 13 mm. With this difference in diameter, the roller 202 directly engages the rail tube 404 at a top contact area 608 at the top of the lower rail tube 404. This configuration leaves an air gap 606 between the roller 202 and each side of the lower rail tube 404. This configuration provides self-cleaning functionality. For instance, dirt or debris on the rail tube 404 can be pushed down, through the air gaps 606, and off the rail as the roller 202 passes over the rail. This configuration reduces wear, increases operational life, and minimizes required maintenance of the sliding door.

In some examples, the sliding door system described here can enable a configuration in which the upper rail 108 and lower rail 106 are non-parallel (e.g., skewed), e.g., such that the vertical spacing between the rails varies along the length of the rails. This flexibility can allow an installer of the sliding door to make the door operate more smoothly on one end of its horizontal travel pathway than the other. In a specific example, the rails 106, 108 can be skewed such that the vertical spacing between the rails towards the rear of the vehicle (e.g., at the fully open position of the door) is less than the vertical spacing between the rails towards the front of the vehicle (e.g., at the fully closed position of the door). In this configuration, a user will feel a gradual increase in pressure as he opens the door. This increase in pressure can be advantageous, e.g., in protecting the door from being slammed into the fully opened position, limiting the force exerted by the door on the rails and extending the lifetime of the door system.

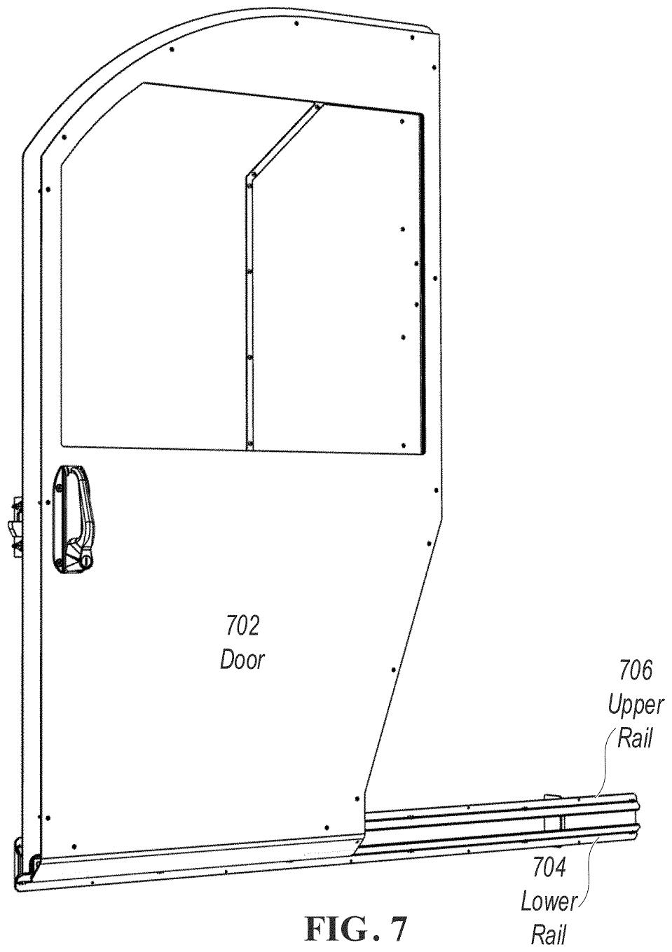

FIG. 7 is a perspective view of a sliding door in an example embodiment with low mounted rails. In the illustrated example, a door 702, unlike door 104 of FIG. 1, is entirely supported by rollers located near the bottom of the door, and mounted to a lower rail 704 and an upper rail 706. This configuration does not include a separate upper rail above the door. This is advantageous in that precise paralleling over distance (e.g., the height of the door) is not required. Furthermore, a lower mounted door enables more flexible payload configurations on the vehicle.

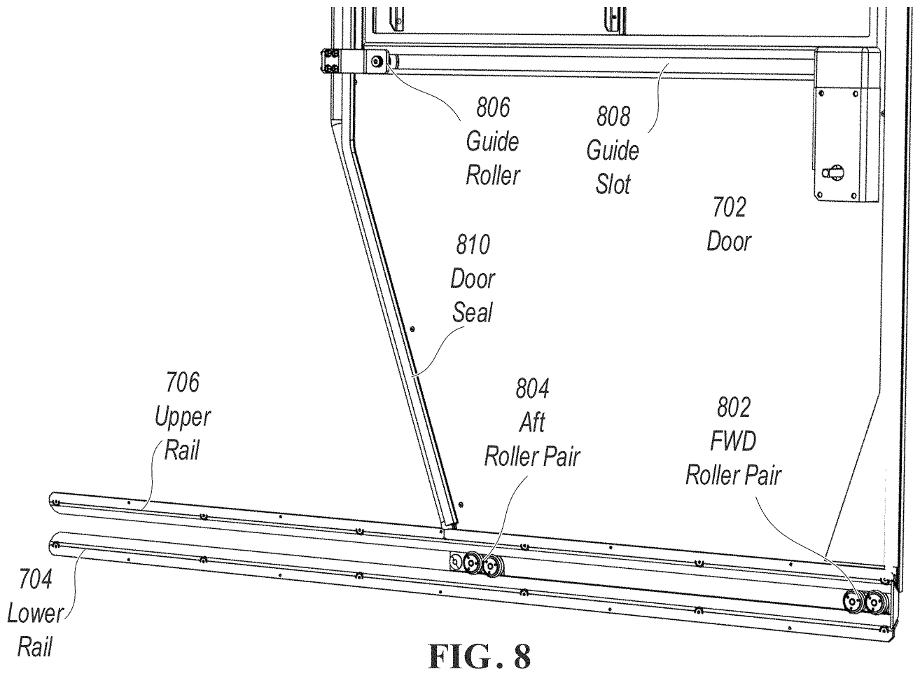

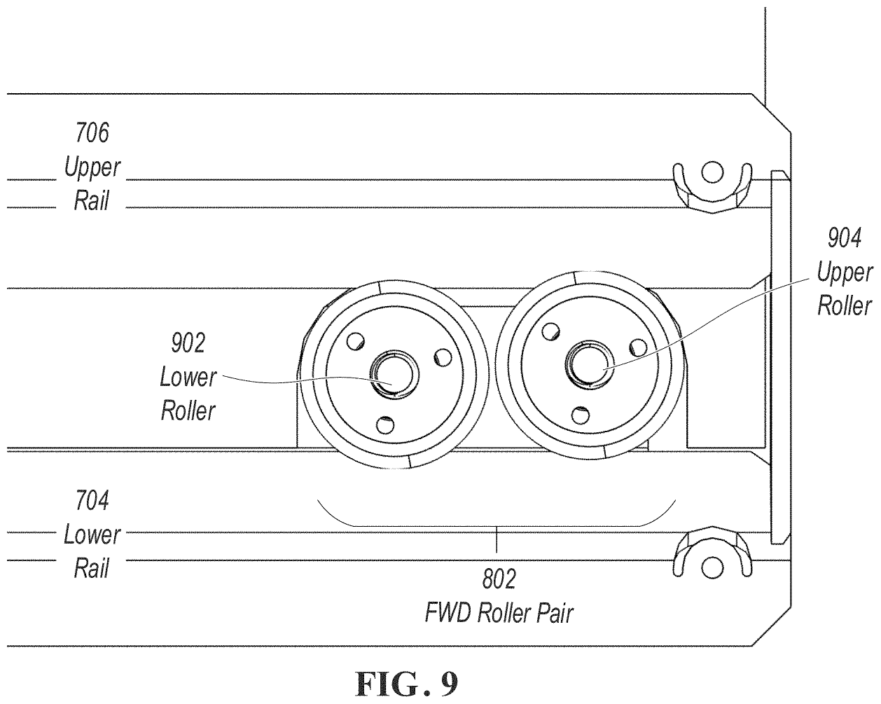

FIG. 8 is an interior perspective view of a sliding door 702 with low mounted rails. The upper rail 706 and lower rail 704 are configured to engage with a forward roller pair 802 and an aft (or rear) roller pair 804. Each roller pair includes two (or more) rollers that can be positioned to engage a particular rail (e.g., upper rail 706). These rollers are shown in greater detail below with respect to FIG. 9. In combination the forward roller pair 802, aft roller pair 804, upper rail 706, and lower rail 704 support the door 702, prevent it from rotating in plane, and allow translation only along the rails.

An additional guide roller 806 is affixed to the vehicle frame, and engages with a guide slot 808 in the vehicle door 702. This guide roller and slot (806, 808) capture the door to the vehicle and prevent out-of-plane rotation of the door. In some implementations the guide roller 806 is a cast or forged metal roller, and can be coated in a coated with an anti-wear substance, such as a powder coat or a high durability polymer painting.

Door seal 810 can be a rubber, polyurethane, or other material that deforms under pressure and forms a seal between the door 702 and the vehicle structure. In some implementations, door seal 810 is a single continuous piece, and can be adhered, or otherwise affixed to the vehicle frame, or the door in order to reduce intake of moisture, dust, or debris into the vehicle from a gap between the vehicle and the door 702.

FIG. 9 is a side view of a roller pair used in a sliding door with low mounted rails. The illustrated forward roller pair 802 includes a lower roller 902 and an upper roller 904. The lower roller 902 is positioned to engage the lower rail 704, while the upper roller 904 engages the upper rail 706. In some implementations, the upper roller 904) is spring biased in an upward direction, in order to ensure positive contact with upper rail 706.

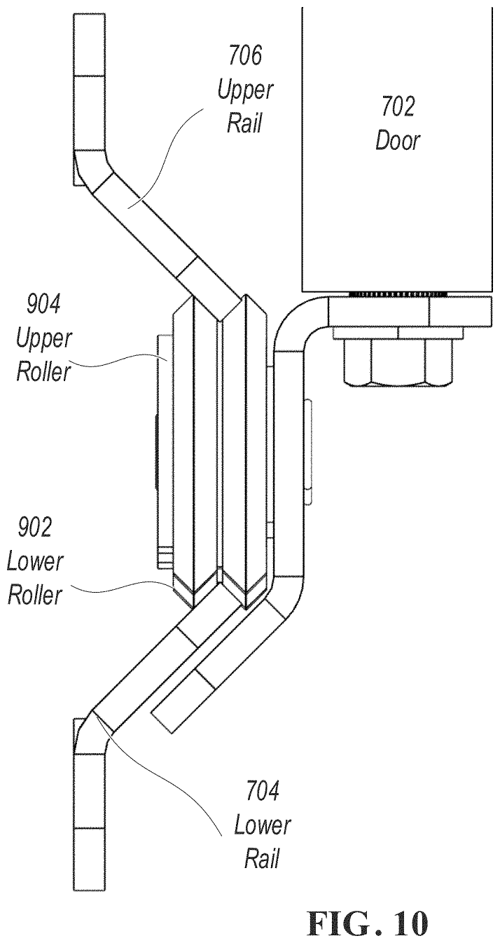

FIG. 10 is a cutaway view illustrating rollers engaged with low mounted rails of a sliding door. In FIG. 10 a cross-section of the upper roller 904 and lower roller 902 is visible, defining a groove that fits over the upper rail 706 and the lower rail 704. In the illustrated implementations, the upper rail 706 and the lower rail 704 are formed of a single bent plate, and can be aluminum, stainless steel, iron, or other alloy, as well as composite materials such as fiberglass or carbon fiber. The rails are bent at an approximately 45 degree angle, insuring that a top or bottom surface of the rail that engages with the rollers is sloped to permit dirt or grit to slide off during operation of the door. This causes the sliding door system to have a self-cleaning effect, and increases operational life, reducing wear. Angled plate rails as illustrated are also less expensive to manufacture and install.

Other features are within the scope of the following claims.

1. A sliding door system for a vehicle, the sliding door system comprising:
a sliding door comprising an upper edge and a lower edge;
a forward roller pair coupled to a forward end of the lower edge of the sliding door, the forward roller pair defining a first lower groove and a first upper groove;
an aft roller pair coupled to an aft end of the lower edge of the sliding door, the aft roller pair defining a second lower groove and a second upper groove;
a lower rail affixed to a frame of the vehicle and disposed vertically below the lower edge of the sliding door, wherein the first lower groove and the second lower groove are engaged with the lower rail; and
an upper rail affixed to the frame of the vehicle and disposed vertically above the lower edge of the sliding door, wherein the first upper groove and the second upper groove are engaged with the upper rail.

2. The system of claim 1, wherein the forward roller pair and the aft roller pair each comprise an upper and a lower roller that are positioned with a relative vertical displacement, and wherein, for each roller pair, the upper roller is configured to engage the upper rail and the lower roller is configured to engage the lower rail.

3. The system of claim 2, wherein the relative vertical displacement between each upper and lower roller is adjustable.

4. The system of claim 2, wherein the upper and lower rollers are formed of a metal alloy and coated with an anti-wear material.

5. The system of claim 2, wherein a spacing between the upper rail and the lower rail causes a compressive force between the upper and lower rollers when the sliding door rests on the lower rail and the upper rollers contact the upper rail.

6. The system of claim 1, wherein the first lower groove, first upper groove, second lower groove, and second upper grove have a triangular cross-section.

7. The system of claim 1, wherein the lower rail and upper rail have a first circular cross-section, and wherein the first lower groove, first upper groove, second lower groove and second upper groove have a second circular cross-section.

8. The system of claim 7, wherein the second circular cross section has a radius that is smaller than the first circular cross-section.

9. The system of claim 1, comprising one or more guides configured to slot over the lower rail, wherein a surface of the one or more guides comprises high density polyethylene (HDPE) or a ceramic.

10. The system of claim 9, wherein the one or more guides are positioned behind the lower roller of the forward roller pair and over the lower rail relative to a front of the vehicle.

11. The system of claim 1, wherein the upper rail and the lower rail are skewed relative to one another.

12. The system of claim 11, wherein a vertical distance between the upper rail and the lower rail toward a front of the vehicle is less than a vertical distance between the upper rail and the lower rail toward a rear of the vehicle.

13. The system claim 1, in which the upper rail is laterally offset from the lower rail relative to the vehicle.

14. The sliding door system of claim 1, wherein the lower rail comprises a lower rail frame affixed to the frame of the vehicle and a lower tube attached to the top of the lower rail frame, and wherein the upper rail comprises an upper rail frame affixed to the frame of the vehicle and an upper tube attached to the bottom of the upper rail frame.

15. The system of claim 14, wherein the lower tube and the upper tube are cylindrical.

16. The system of claim 1, comprising a spring arm configured to adjust a height of the upper roller relative to the upper edge of the sliding door.

17. The system of claim 1, wherein the sliding door comprises a guide slot positioned between the upper edge and the lower edge and configured to receive a guide roller.

18. The system of claim 17, wherein the guide roller is affixed to the frame of the vehicle and is configured to limit lateral motion of the sliding door.

19. The system of claim 1, wherein the sliding door is non-planar.

20. The system of claim 19, wherein the sliding door, upper rail, and lower rail follow a non-linear path along the vehicle frame.
